(19) United States
(12) Patent Application Publication
(10) Pub. No.: US 2010/0102726 A1
(43) Pub. Date: Apr. 29, 2010

(54) ILLUMINATION APPARATUS AND MANUFACTURING METHOD THEREOF

(76) Inventor: Hsin-Po HSIEH, Changhua County (TW)

Correspondence Address: BIRCH STEWART KOLASCH & BIRCH, PO BOX 747, FALLS CHURCH, VA, 22040-0747, US

(21) Appl. No.: 12/582,281

(22) Filed: Oct. 20, 2009

(30) Foreign Application Priority Data
Oct. 24, 2008 (TW) 097141004

(51) Int. Cl. H01J 7/44; H01J 1/62; H01J 9/00

(52) U.S. Cl. 315/56; 313/493; 445/26

(57) ABSTRACT

An illumination apparatus includes a base and a C/U-shaped spiral fluorescence tube. The C/U-shaped spiral fluorescence tube is disposed on the base and has a first spiral part, a second spiral part and a C/U-shaped bending part. One end of the first spiral part connects to one end of the C/U-shaped bending part, and the other end of the first spiral part is disposed with an electrode. One end of the second spiral part connects to the other end of the C/U-shaped bending part, and the other end of the second spiral part is disposed with another electrode.

### CROSS REFERENCE TO RELATED APPLICATIONS

This Non-provisional application claims priority under 35 U.S.C. §119(a) on Patent Application No(s). 097141004 filed in Taiwan, Republic of China on Oct. 24, 2008, the entire contents of which are hereby incorporated by reference.

### BACKGROUND OF THE INVENTION

1. Field of Invention

The present invention relates to an illumination apparatus and a manufacturing method thereof, and in particular, to an illumination apparatus with a tube lamp and a manufacturing method thereof.

2. Related Art

According to the enable mechanisms, the typical fluorescent lamps can be classified into the hot cathode fluorescent lamp (HCFL) and cold cathode fluorescent lamp (CCFL). The HCFL is the commonly used lamp in our houses and offices, and it has a filament therein so that the diameter thereof is larger than that of the CCFL.

Regarding to the CCFL, the mercury and low-pressure gas (e.g. inert gas) are sealed therein, the fluorescent material is coated on the inner wall thereof, and two electrodes are configured at two ends thereof for connecting the power source. When the high-level voltage is applied to the electrodes, the ionized electrons in the lamp are speeded up by the electronic field to excite the atoms of the low-pressure gas. Consequently, the mercury atoms can be ionized to emit UV light, which can excite the fluorescent material to generate the visible light with corresponding color temperature.

The structure of the CCFL is simpler than that of the HCFL and the CCFL has the advantages of smaller lamp tube, lower temperature and longer lifetime, so that the CCFL is suitable for serving as the light source of various kinds of electronic apparatuses.

However, it is still desired to improve the total brightness of the illumination apparatus, which uses the CCFL or HCFL as its light source.

### SUMMARY OF THE INVENTION

In view of the foregoing, the present invention is to provide an illumination apparatus containing a spiral tube with better brightness and a manufacturing method thereof.

To achieve the above, the present invention discloses an illumination apparatus including a base and a C/U-shaped spiral fluorescence tube (fluorescent tube in the following description). The fluorescence tube is disposed on the base and has a first spiral part, a second spiral part and a C/U-shaped bending part. One end of the first spiral part connects to one end of the C/U-shaped bending part, and the other end of the first spiral part is disposed with an electrode. One end of the second spiral part connects to the other end of the C/U-shaped bending part, and the other end of the second spiral part is disposed with another electrode

In some embodiments, the fluorescent tube is a CCF (cold cathode fluorescent) tube or a HCF (hot cathode fluorescent) tube, and the C/U-shaped bending part has a C shape or a U shape. The first and second spiral parts are spirally wreathed with at least one spiral radius, and the C/U-shaped bending part has a curvature radius smaller than the spiral radius. Each of the first and second spiral parts has a plurality of circles, and the first and second spiral parts are spirally wreathed in parallel or toward opposite directions.

Regarding to one aspect, the first and second spiral parts are disposed between the base and the C/U-shaped bending part. In this case, the C/U-shaped bending part is located at the top of the fluorescent tube, the base is disposed adjacent to the bottom of the fluorescent tube, and the first and second spiral parts are located between the top and bottom of the fluorescent tube. Regarding to another aspect, the C/U-shaped bending part is disposed between the first and second spiral parts. In this case, the second spiral part is located between the base and the C/U-shaped bending part, and the C/U-shaped bending part is roughly located at the center between the top and bottom of the fluorescent tube.

The spiral radius of the fluorescent tube may be variable, for example, along the axis of the circles of the fluorescent tube. In addition, the fluorescent tube may further include a third spiral part and a fourth spiral part. The C/U-shaped bending part connects to the first and second spiral parts, respectively. The third spiral part is disposed between the base and the first spiral part, and the fourth spiral part is disposed between the base and the second spiral part. The spiral radius of the first spiral part is smaller than that of the third spiral part, and the spiral radius of the second spiral part is smaller than that of the fourth spiral part. Alternatively, the spiral radius of the first spiral part may be greater than that of the third spiral part, and the spiral radius of the second spiral part may be greater than that of the fourth spiral part.

In addition, the illumination apparatus may further include a housing, a driving circuit and a reflective element. The housing covers the fluorescence tube and is assembled with the base. The fluorescent tube is disposed around the driving circuit or the reflective element. The reflective element can reflect the light emitted by the fluorescent tube so as to increase the brightness of the illumination apparatus. Besides, the reflective element may cover at least one part of the driving circuit.

The driving circuit is disposed on the base, and at least one electrode of the fluorescent tube is electrically connected with the driving circuit.

The driving circuit can be an inverter or a part of the inverter. In addition, the driving circuit may include other electronic elements such as a coil or circuit board.

Moreover, the illumination apparatus may include a plurality of fluorescent tubes and a plurality of electrodes, and the number of the electrodes is twice of that of the fluorescent tubes. The fluorescent tubes are disposed in parallel and spirally wreathed separately. The electrodes are disposed at the ends of the fluorescent tubes, respectively.

In addition, the present invention also discloses a manufacturing method of an illumination apparatus including the following steps of: bending a linear fluorescence tube to form a C/U-shaped fluorescence tube, which has a first part, a second part and a C/U-shaped bending part; and bending the first part and the second part from the C/U-shaped bending part to shape the first part and the second part in spiral. Herein, two ends of the C/U-shaped bending part are connected with the first part and the second part, respectively.

As mentioned above, the illumination apparatus of the present invention has a spirally wreathed C/U-shaped spiral fluorescent tube, so that the brightness thereof can be increased. Instead of bending the linear fluorescent tube from the S-shaped bending part as the prior art, the present invention is to bend the linear portions of the C/U-shaped bending part. Thus, the fabrication of the spiral fluorescent tube of the invention is much easier. In addition, it is also easier to form the C/U-shaped bending part than forming the S-shaped bending part in advance.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a side view of an illumination apparatus according to a preferred embodiment of the present invention;

FIG. 2 is a top view of the illumination apparatus of FIG. 1;

FIG. 3 is a side view of another illumination apparatus according to the preferred embodiment of the present invention;

FIG. 4 is a side view of another illumination apparatus according to the preferred embodiment of the present invention;

FIG. 5 is a top view of the illumination apparatus of FIG. 4;

FIG. 6 is a side view of another illumination apparatus according to the preferred embodiment of the present invention;

FIG. 7 is a side view of another illumination apparatus according to the preferred embodiment of the present invention;

FIG. 8 is a top view of the illumination apparatus of FIG. 7; and

FIG. 9 is a flow chart of a manufacturing method of the illumination apparatus according to the preferred embodiment of the present invention.

### DETAILED DESCRIPTION OF THE INVENTION

The present invention will be apparent from the following detailed description, which proceeds with reference to the accompanying drawings, wherein the same references relate to the same elements.

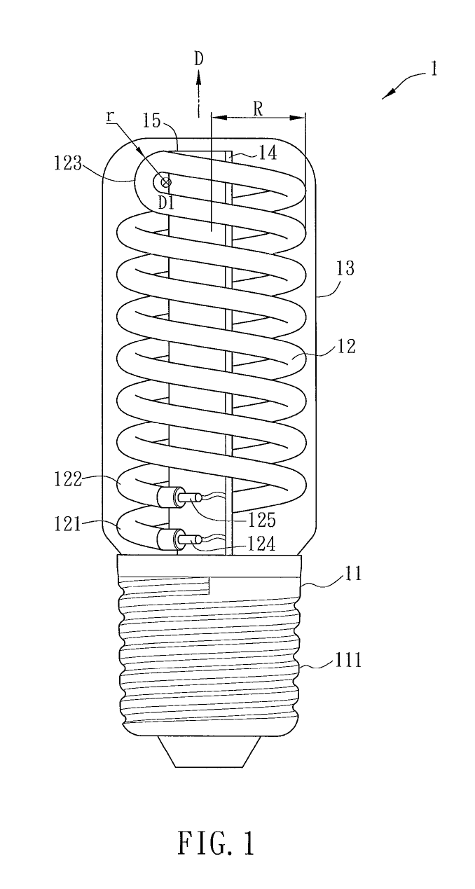

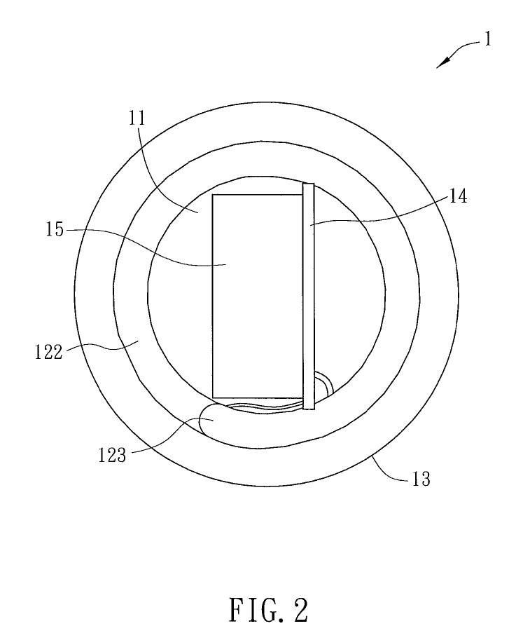

Please refer to FIG. 1 and FIG. 2, which are the side view and top view of an illumination apparatus 1 according to a preferred embodiment of the present invention.

The illumination apparatus 1 includes a base 11, and a C/U-shaped spiral fluorescent tube 12. The fluorescent tube 12 is disposed on the base 11 and has a first spiral part 121, a second spiral part 122 and a C/U-shaped bending part 123. One end of the first spiral part 121 connects to one end of the bending part 123, and the other end of the first spiral part 121 is disposed with an electrode 124. One end of the second spiral part 122 connects to the other end of the bending part 123, and the other end of the second spiral part 122 is disposed with another electrode 125.

In addition, the illumination apparatus 1 further includes a housing 13, a driving circuit 14, and a reflective element 15. The first spiral part 121 and the second spiral part 122 are spirally wreathed on the base 11, and the ends thereof that disposed with the electrodes 124 and 125 are sealed.

The first spiral part 121 and the second spiral part 122 are disposed between the bending part 123 and the base 11. In more detailed, the bending part 123 is disposed at the top of the fluorescent tube 12, the base 11 is disposed adjacent to the bottom of the fluorescent tube 12, and the first and second spiral parts 121 and 122 are disposed between the top and bottom of the fluorescent tube 12. In other words, in the view along an axis D that is perpendicular to the base 11 with regarding the base 11 as the bottom, the positions of the base 11, the two spiral parts 121 and 122, and the bending part 123 are individually from bottom to top.

The internal tube channel of the bending part 123 is connected to and located between the internal tube channels of the first spiral part 121 and the second spiral part 122. The first spiral part 121 and the second spiral part 122 are spirally wreathed with at least one spiral radius R, and the bending part 121 has a curvature radius r smaller than the spiral radius R of the first spiral part 121 and the second spiral part 122. In this embodiment, the spiral radius R is, for example but not limited to be, twice or more of the curvature radius r.

The distance between two ends of the bending part 123, which are respectively connected with the first spiral part 121 and the second spiral part 122, is about 0-20 mm and is preferably 10-15 mm, and the spiral radius R is about 35-40 mm

The first spiral part 121 and the second spiral part 122 are spirally wreathed roughly along the axis D that is perpendicular to the base 11. In this embodiment, the bending part 123 is curved about an axis D1 that is parallel to the base 11 rather than the axis D. As mentioned above, the axis D about which the first and second spiral parts 121 and 122 are spirally wreathed and the axis D1 about which the bending part 123 is curved can form an included angle.

The openings of two ends of the bending part 123 both face towards the same direction. The entire bending part 123 can be a continuously curved arc such as a C-shaped arc. Alternatively, the bending part 123 may be composed of two 90-degree elbow tubes and one linear tube connecting the elbow tubes to form a U shape. In this U shaped case, the curvature radius r is to define the curvature of the elbow tubes.

The bending part 123 is located on and assembled with the base 11, and each of the first and second spiral parts 121 and 122 has a plurality of circles around the driving circuit 14 and the reflective element 15.

Expect for the above-mentioned configuration that the fluorescent tube 12 is assembled with the base 11, the fluorescent tube 12 may be assembled with the housing 13, the driving circuit 14 or the reflective element 15. In addition, the fluorescent tube 12 can be assembled with one or two of the base 11, the housing 13, the driving circuit 14 and the reflective element 15.

In the embodiment, the housing 13 covers the driving circuit 14, the fluorescent tube 12, the electrodes 124 and 125, and the reflective element 15, and is assembled with the base 11.

Alternatively, the housing 13 may completely or partially cover the above-mentioned elements. For example, the housing 13 may partially cover the fluorescent tube 12. In addition, the housing 13 can be transparent or partially reflective, and it may have a plurality of grids or a side wall around the fluorescent tube 12 with an opening on the top of the fluorescent tube 12.

The driving circuit 14 is disposed on and assembled with the base 11, and the electrodes 124 and 125 are electrically connected with the driving circuit 14 by, for example, wire connection or welding.

Regarding to the electronic property, the driving circuit 14 can be an inverter or a part of the inverter. In practice, the driving circuit 14 includes a circuit board, coil or other electronic elements such as the circuit board of an inverter or the coil of a converter. In this embodiment, the driving circuit 14 is a part of an inverter and is a circuit board, and the residual parts of the inverter are disposed inside the base 11. Besides, the driving circuit 14 can be a coil, such as a secondary coil of a converter of the inverter, and the primary coil of the converter and the residual parts of the inverter are disposed inside the base 11.

The base 11 includes an electronic connection part 111, such as a screw cap (Edison cap), for inserting into a lamp holder, so that the illumination apparatus 1 can be installed in the lamp holder to retrieve the power supply. Consequently, after the power is applied to the driving circuit 14, it can drive the fluorescent tube 12 to emit light.

The reflective element 15 can reflect the light emitted from the fluorescent tube 12, so that the brightness of the illumination apparatus 1 can be increased. For example, the reflective element 15 can be a metal or plastic shell, and at least one part of the driving circuit 14 can be disposed in the reflective element 15.

In addition, the electrodes 124 and 125 can be disposed in the base 11 and electrically connected with other electronic elements inside the base 11 by, for example, wire connection or welding.

The fluorescent tube 12 can be made starting from a C/U-shaped fluorescent tube, which is sealed, contains low-pressure gas and mercury therein, and has electrodes disposed at two ends thereof. After heating the C/U-shaped fluorescent tube, it is spirally bended about an axis. The low-pressure gas and mercury sealed inside the fluorescent tube can be uniformly distributed.

As mentioned above, when using the U-shaped fluorescent tube to manufacturing the illumination apparatus, the spiral fluorescent tube thereof can have a U-shaped bending part; when using the C-shaped fluorescent tube to manufacturing the illumination apparatus, the spiral fluorescent tube thereof can have a C-shaped bending part. In this embodiment, the C/U-shaped fluorescent tube is spirally bended to form the desired spiral fluorescent tube. Herein, the bending portion of the C/U-shaped fluorescent tube is remained, and the linear portions thereof are spirally wreathed. Thus, the bending portion of the C/U-shaped fluorescent tube is corresponding to the C/U-shaped bending part of the desired C/U-shaped spiral fluorescent tube, and the linear portions thereof will be bended to form the first and second spiral parts of the desired C/U-shaped spiral fluorescent tube. The difference between the C shape and U shape can be referred to the previous description.

Since the C/U-shaped spiral fluorescent tube includes a plurality of circles, the brightness thereof can be efficiently increased. In addition, because the C/U-shaped spiral fluorescent tube is a CCF tube, it still keeps the advantages of the CCFL such as longer lifetime, lower temperature, lower power consumption, and more stable electronic properties.

In addition, the fluorescent tube 12 can also be made starting from a C/U-shaped fluorescent tube, which is not sealed. Firstly, the non-sealed C/U-shaped fluorescent tube is spirally bended. Next, the low-pressure gas and mercury are filled into the C/U-shaped fluorescent tube, and then the C/U-shaped fluorescent tube is sealed. Of course, the fluorescent tube 12 can be manufactured with a HCF tube.

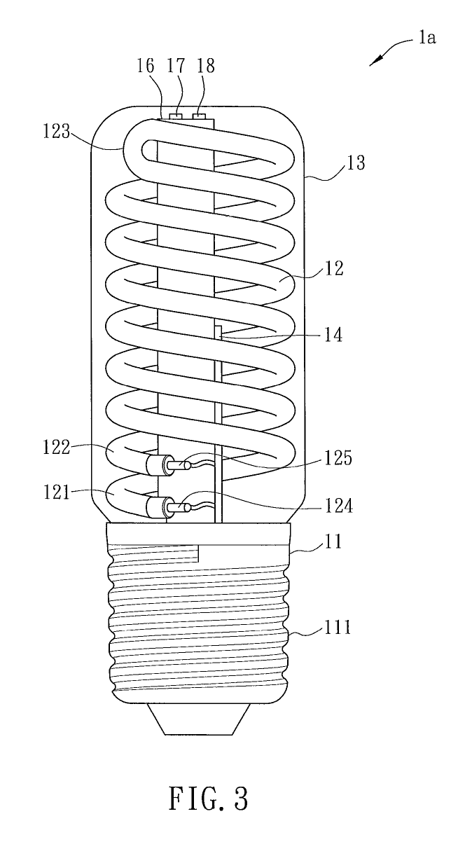

With reference to FIG. 3, an illumination apparatus 1a of this embodiment further includes a supporting element 16 and a sensing unit 17. In this embodiment, the C/U-shaped spiral fluorescent tube 12 is disposed around the supporting element 16, and the sensing unit 17 is disposed on the supporting element 16. Foe example, the sensing unit 17 can be disposed at the top of the supporting element 16, so that it can be positioned adjacent to the housing 13.

The supporting element 16 can be made of metal, alloy, ceramics, glass or plastic, and may have a surface forming a reflective layer or surface for reflecting the light emitted from the inner portions of the fluorescent tube 12. Thus, the brightness of the illumination apparatus 1a can be increased. In addition, the supporting element 16 can support the driving circuit 14, or it may accommodate at least one part of the driving circuit 14.

The sensing unit 17 may, for example, include an image sensing element, a light sensing element, a thermal sensing element, a sound sensing element, a RF sensing element, an electromagnetic sensing element, or their combinations. Of course, the sensing unit 17 may be electrically connected with the driving circuit 14.

Accordingly, the illumination apparatus 1a may be automatically turned on/off by sensing a moving object with the sensing unit 17. Furthermore, the sensing unit 17 can also be used as a fire alert, thereby broadening the application scopes of the illumination apparatus 1a. Moreover, the sensing unit 17 can detect the lighting intensity of the fluorescent tube 12 and feedback to the driving circuit 14, so that the driving circuit 14 can control the lighting intensity of the fluorescent tube 12.

Except for the sensing unit 17, the illumination apparatus 1a may further include a wireless transmission unit 18 disposed on the supporting element 16, too. For example, the wireless transmission unit 18 may be disposed at the top of the supporting element 16 for transmitting signals. The wireless transmission unit 18 includes an optical communication element, wireless communication element, or their combinations. In this embodiment, the optical communication element may include a photo diode, laser diode, or photo transistor, and the wireless communication element may include an antenna, amplifier, or access point. The illumination apparatus 1a with the wireless transmission unit 18 can be used as a wireless communication transceiver, thereby broadening the application scopes of the illumination apparatus 1a.

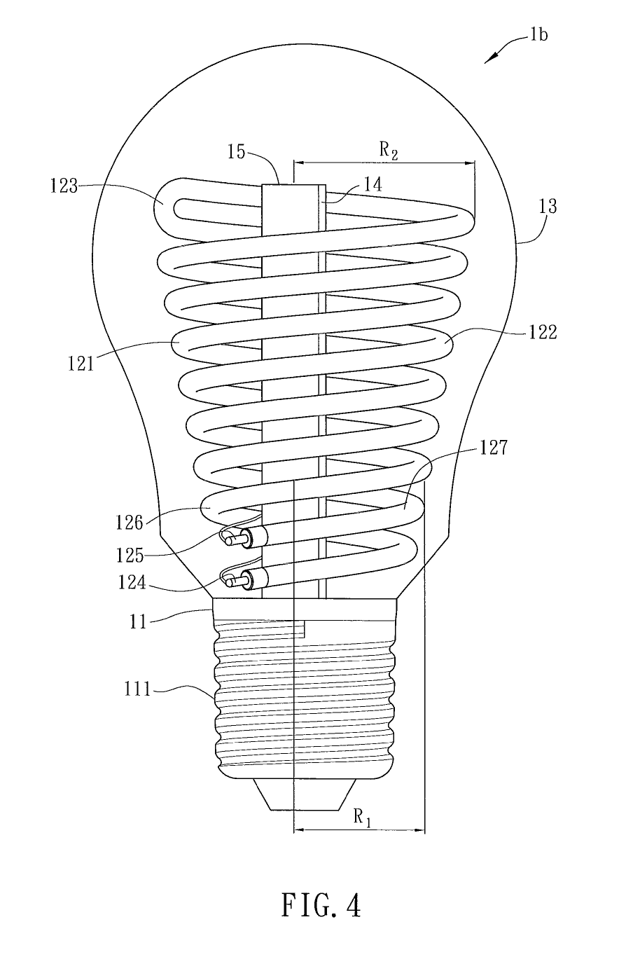

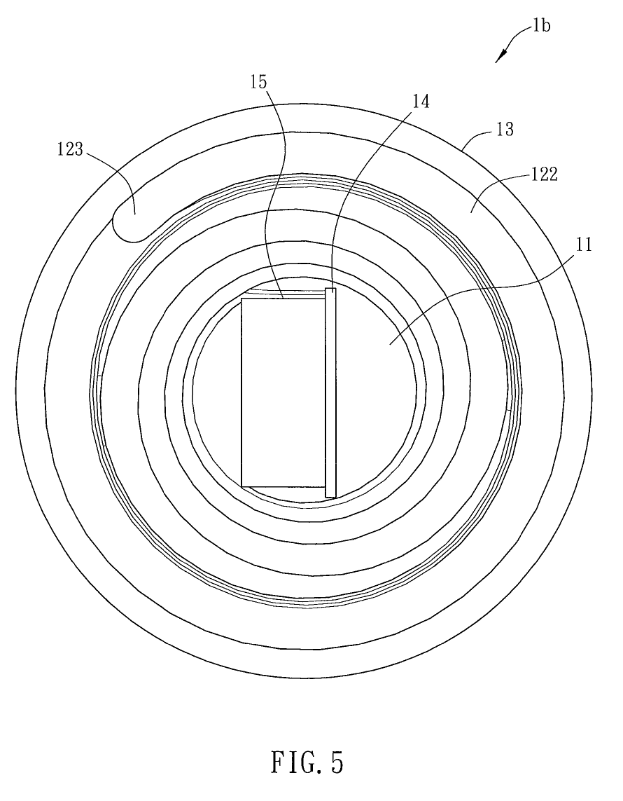

The spiral radius of the fluorescent tube 12 may be variable, for example, along the axis of the circles of the fluorescent tube 12. As shown in FIGS. 4 and 5, which are the side view and top view of another illumination apparatus 1b of the present embodiment, the fluorescent tube 12 of the illumination apparatus 1b further includes a third spiral part 126 and a fourth spiral part 127.

Two ends of the first spiral part 121 are connected with the bending part 123 and the third spiral part 126, respectively, and two ends of the second spiral part 122 are connected with the bending part 123 and the fourth spiral part 127, respectively. The third spiral part 126, the first spiral part 121, the bending part 123, the second spiral part 122 and the fourth spiral part 127 are connected in order to form a channel. The third spiral part 126 is disposed between the base 11 and the first spiral part 121, and the fourth spiral part 127 is disposed between the base 11 and the second spiral part 122. The spiral radius R₂ of the first spiral part 121 is greater than the spiral radius R₁ of the third spiral part 126, and the spiral radius of the second spiral part 122 is greater than that of the fourth spiral part 127. Alternatively, the spiral radius of the first spiral part 121 may be smaller than that of the third spiral part 126, and the spiral radius of the second spiral part 122 may be smaller than that of the fourth spiral part 127.

In this embodiment, the spiral radius of the second spiral part 122 is equal to the spiral radius R₂ of the first spiral part 121, and the spiral radius of the fourth spiral part 127 is equal to the spiral radius R₁ of the third spiral part 126. Otherwise, the spiral radius of the second spiral part 122 may be different from the spiral radius R₂ of the first spiral part 121, and the spiral radius of the fourth spiral part 127 may also be different from the spiral radius R₁ of the third spiral part 126.

The spiral radius of the fluorescent tube 12 is gradually increased from the bottom to the top, so that the light shielded by the adjacent parts of the fluorescent tube 12 can be reduced so as to increase the total brightness.

Since the structure, function, connection, fabrication and variations of the elements of this embodiment, such as the base, electronic element, spiral fluorescent tube, electrodes, reflective element and housing, are the same as or similar to those of the previous or following embodiment, the detailed descriptions thereof will be omitted.

In another aspect of the embodiment, the reflective element may be removed from the illumination apparatus, and the electronic element is disposed inside the base.

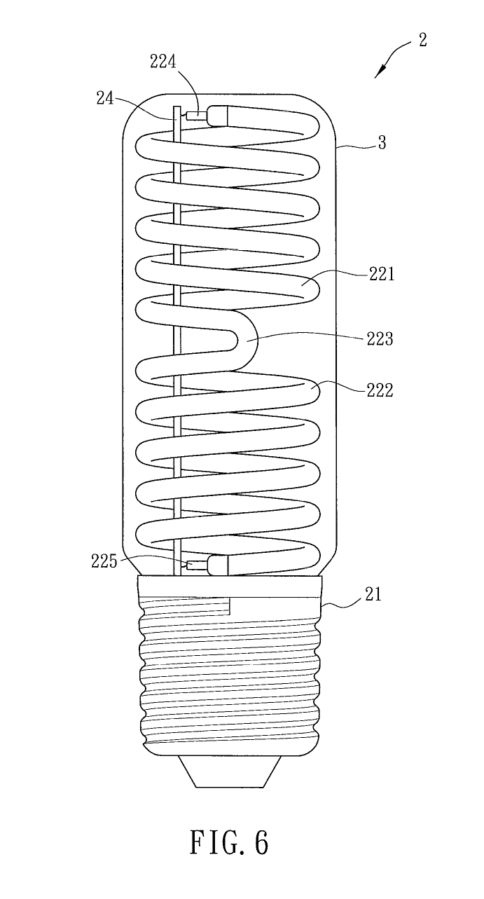

FIG. 6 is a side view of an illumination apparatus 2 according to another embodiment of the present invention.

In the illumination apparatus 2, the first spiral part 221 and the second spiral part 222 of the C/U-shaped spiral fluorescent tube 22, each of which has a plurality of circles, are spirally wreathed toward opposite directions. One end of the fluorescent tube 22 is disposed close to the base 21, and the other end thereof is disposed away from the base 21. The C/U-shaped bending part 223 is disposed between the first spiral part 221 and the second spiral part 222, and the second spiral part 222 is located between the C/U-shaped bending part 223 and the base 21. The C/U-shaped bending part 223 is roughly located at the center between the top and bottom of the fluorescent tube 22.

The electrodes 224 and 225 are connected with the driving circuit 24, which is disposed on the base 21. Otherwise, the electrodes 224 and 225 may be connected with wires. The reflective element is not necessary in this embodiment. Of course, in other aspects, the illumination apparatus 2 may still be configured with the reflective element.

Since the structure, function, connection, fabrication and variations of the elements of this embodiment, such as the base, electronic element, spiral fluorescent tube, electrodes, reflective element and housing, are the same as or similar to those of the previous or following embodiment, the detailed descriptions thereof will be omitted.

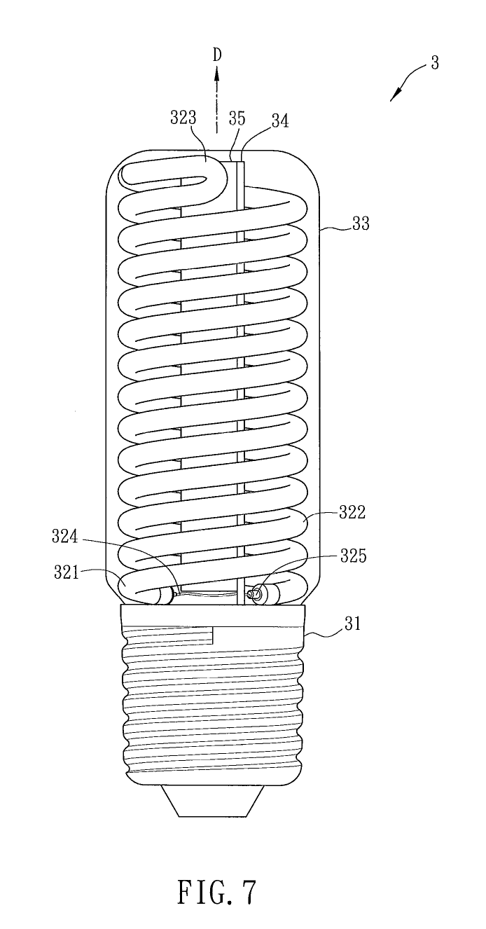

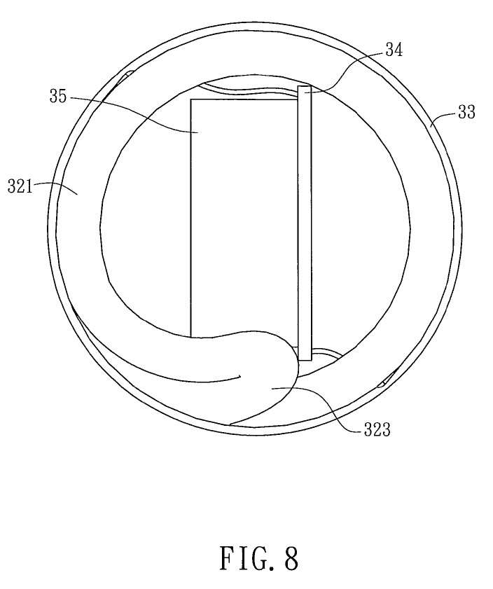

FIGS. 7 and 8 are a side view and a top view of an illumination apparatus 3 according to another embodiment of the present invention.

The lengths of the first spiral part 321 and the second spiral part 322 of the C/U-shaped spiral fluorescent tube 32 are different. The ends of the first spiral part 321 and the second spiral part 322, which are disposed with the electrodes 324 and 325, are disposed towards opposite directions, and the first spiral part 321 has half a circle more than the second spiral part 322. That is, the length of the first spiral part 321 is longer than that of the second spiral part 322 by π×(spiral radius). Accordingly, the ends of the fluorescent tube 32 can be located at the same plane, which may facilitate the assembling of the illumination apparatus 3.

In addition, the direction of the end of the first spiral part 321 disposed with the electrode 324 and the direction of the end of the second spiral part 322 disposed with the electrode 325 may have an included angle. That is, they are not in parallel to each other.

The first spiral part 321 and the second spiral part 322 are spirally wreathed roughly along the axis D that is perpendicular to the base 31. In this embodiment, the CM-shaped bending part 323 is curved about neither the axis D nor the direction parallel to the base 31. As shown in FIG. 7, the C/U-shaped bending part 323 is curved about an axis having an included angle with the axis D and another included angle with the direction parallel to the base 31.

Since the structure, function, connection, fabrication and variations of the elements of this embodiment, such as the base, electronic element, C/U-shaped spiral fluorescent tube, electrodes, reflective element and housing, are the same as or similar to those of the previous or following embodiment, the detailed descriptions thereof will be omitted.

In another embodiment (not shown), the first spiral part and the second spiral part are spirally wreathed roughly along an axis that is perpendicular to the base. In this case, the C/U-shaped bending part is curved about another axis that is also perpendicular to the base instead of the previously mentioned axis. That is, the axis along which the first spiral part and the second spiral part are spirally wreathed is substantially parallel to the other axis about which the CM-shaped bending part is curved.

Since the structure, function, connection, fabrication and variations of the elements of this embodiment, such as the base, electronic element, spiral fluorescent tube, electrodes, reflective element and housing, are the same as or similar to those of the previous or following embodiment, the detailed descriptions thereof will be omitted.

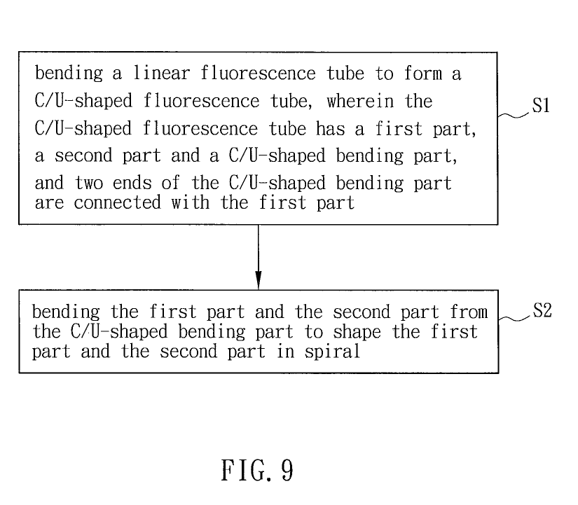

FIG. 9 is a flow chart of a manufacturing method of an illumination apparatus according to the preferred embodiment of the present invention.

The manufacturing method of the illumination apparatus includes the following steps S1 and S2. The step S1 is to bend a linear fluorescence tube to form a C/U-shaped fluorescence tube. In this case, the C/U-shaped fluorescence tube has a first part, a second part and a C/U-shaped bending part, and two ends of the C/U-shaped bending part are connected with the first and second parts, respectively.

The step S2 is to bend the first part and the second part to shape them in spiral. Accordingly, the first and second parts can be shaped to be corresponding to the first and second spiral parts of the previous embodiments. If the spiral radius is varied during the bending process, the first part can be shaped to corresponding to the above-mentioned first and third spiral parts, and the second part can be shaped to corresponding to the above-mentioned second and fourth spiral parts.

After the C/U-shaped fluorescent tube is formed, the inert gas and fluorescent powder can be filled into the tube and the two ends of the fluorescent tube are sealed and disposed with the electrodes before the spirally bending process (step S2). Thus, the C/U-shaped fluorescent tube is manufactured in advance for the following process to fabricate the desired C/U-shaped spiral fluorescent tube. In addition, the C/U-shaped fluorescent tube can be a CCF tube or a HCF tube. Since the aspects of the C/U-shaped fluorescent tube and C/U-shaped spiral fluorescent tube are illustrated in the previous embodiments, the detailed descriptions thereof will be omitted.

In addition, the processes for filling the inert gas and fluorescent powder, sealing the tube and disposing the electrodes can also be performed after the spirally bending process (step S2). It can be decided at this moment to fabricate the C/U-shaped spiral fluorescent tube as a CCF tube or a HCF tube.

Furthermore, the manufacturing method of the illumination apparatus of this embodiment may further include the steps of disposing a housing, disposing a driving circuit, and/or disposing a reflective element. Accordingly, the illumination apparatus of the previously mentioned embodiments can be manufactured.

In summary, the illumination apparatus of the present invention has a spirally wreathed C/U-shaped spiral fluorescent tube, so that the brightness thereof can be increased. Instead of bending the linear fluorescent tube from the S-shaped bending part as the prior art, the present invention is to bend the linear portions of the C/U-shaped bending part. Thus, the fabrication of the spiral fluorescent tube of the invention is much easier. In addition, it is also easier to form the C/U-shaped bending part than forming the S-shaped bending part in advance.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An illumination apparatus, comprising:
a base; and
a C/U-shaped spiral fluorescence tube disposed on the base and having a first spiral part, a second spiral part and a C/U-shaped bending part, wherein one end of the first spiral part connects to one end of the C/U-shaped bending part, the other end of the first spiral part is disposed with an electrode, one end of the second spiral part connects to the other end of the C/U-shaped bending part, and the other end of the second spiral part is disposed with another electrode.

2. The illumination apparatus according to claim 1, wherein the first spiral part and the second spiral part are spirally wreathed with at least one spiral radius, and the C/U-shaped bending part has a curvature radius smaller than the spiral radius.

3. The illumination apparatus according to claim 1, further comprising:
a housing covering the C/U-shaped spiral fluorescence tube and assembled with the base.

4. The illumination apparatus according to claim 1, wherein the first spiral part and the second spiral part are disposed between the base and the C/U-shaped bending part.

5. The illumination apparatus according to claim 1, wherein the first spiral part and the second spiral part are spirally wreathed in parallel, and each of the first spiral part and the second spiral part has a plurality of circles.

6. The illumination apparatus according to claim 1, wherein the C/U-shaped bending part is disposed between the first spiral part and the second spiral part, and the second spiral part is disposed between the base and the C/U-shaped bending part.

7. The illumination apparatus according to claim 1, wherein the first spiral part and the second spiral part are spirally wreathed toward opposite directions, and each of the first spiral part and the second spiral part has a plurality of circles.

8. The illumination apparatus according to claim 1, wherein the C/U-shaped spiral fluorescence tube further has a third spiral part disposed between the base and the first spiral part, and a fourth spiral part disposed between the base and the second spiral part, the spiral radius of the first spiral part is smaller than that of the third spiral part, and the spiral radius of the second spiral part is smaller than that of the fourth spiral part.

9. The illumination apparatus according to claim 1, wherein the C/U-shaped spiral fluorescence tube further has a third spiral part disposed between the base and the first spiral part, and a fourth spiral part disposed between the base and the second spiral part, the spiral radius of the first spiral part is greater than that of the third spiral part, and the spiral radius of the second spiral part is greater than that of the fourth spiral part.

10. The illumination apparatus according to claim 1, wherein the lengths of the first spiral part and the second spiral part are different.

11. The illumination apparatus according to claim 1, further comprising:
a driving circuit disposed at the substrate.

12. The illumination apparatus according to claim 11, wherein the driving circuit is disposed on the base, and the electrodes are electrically connected with the driving circuit.

13. The illumination apparatus according to claim 1, further comprising:
an electronic element disposed on the substrate, wherein the electronic element is a converter or a coil.

14. The illumination apparatus according to claim 1, further comprising:
a reflective element, wherein the C/U-shaped spiral fluorescence tube is disposed around the reflective element.

15. The illumination apparatus according to claim 1, further comprising:
a supporting element, wherein the C/U-shaped spiral fluorescence tube is disposed around the supporting element.

16. The illumination apparatus according to claim 15, further comprising:
a sensing unit disposed on the supporting element.

17. The illumination apparatus according to claim 15, further comprising:
a wireless transmission unit disposed on the supporting element.

18. A manufacturing method of an illumination apparatus, comprising the steps of:
bending a linear fluorescence tube to form a C/U-shaped fluorescence tube, wherein the C/U-shaped fluorescence tube has a first part, a second part and a C/U-shaped bending part, and two ends of the C/U-shaped bending part are connected with the first part and the second part, respectively; and
bending the first part and the second part from the C/U-shaped bending part to shape the first part and the second part in spiral.

19. The method according to claim 18, further comprising a step of:
sealing the C/U-shaped fluorescence tube.

20. The method according to claim 18, wherein the C/U-shaped fluorescence tube is a cold cathode fluorescent (CCF) tube.
